(19) United States
(12) Patent Application Publication
(10) Pub. No.: US 2011/0005430 A1
(43) Pub. Date: Jan. 13, 2011

(54) USE OF CALCIUM PHOSPHATES IN ASPHALT MIXES

(76) Inventor: Jean-Valery Martin, Princeton, NJ (US)

Correspondence Address: MCCARTER & ENGLISH, LLP HARTFORD;CITYPLACE I, 185 ASYLUM STREET, HARTFORD, CT, 06103, US

(21) Appl. No.: 12/831,922

(22) Filed: Jul. 7, 2010

Related U.S. Application Data
(60) Provisional application No. 61/223,527, filed on Jul. 7, 2009.

(51) Int. Cl. C08L 95/00

(52) U.S. Cl. 106/284.04; 106/284.03; 524/71

(57) ABSTRACT

Improved asphalt pavement mixes containing calcium phosphate and processes for producing the improved pavement mixes are provided. The asphalt pavement compositions comprise aggregate, asphalt binder and calcium phosphate. The improved pavement mixes may be produced by blending calcium phosphate with the aggregate prior to combining the aggregate with the asphalt binder. Alternatively, the calcium phosphate may be mixed with the asphalt binder prior to adding the aggregate to the asphalt binder. The addition of calcium phosphate to the asphalt pavement mixtures can improve the stiffness or the moisture resistance of the asphalt pavement mix.

This application claims priority under 35 U.S.C. §119(e) to U.S. Provisional Application Ser. No. 61/223,527 filed on Jul. 7, 2009, the contents of which are hereby incorporated in their entirety.

### BACKGROUND

Asphalt pavements typically comprise an asphalt binder, an aggregate material, such as crushed stone, and various additives to improve performance. Moisture induced damage of asphalt pavement is a significant problem in maintaining roads and bridges. Moisture induced damage can manifest itself in the form of raveling, pot holes or asphalt stripping. These types of damage are related to the loss of the ability of the asphalt to bond with the aggregate surface due to repeated contact with water.

Raveling is the progressive separation of aggregate particles in a pavement from the surface downward or from the edges inward. As the aggregate particles are separated from the asphalt, the pavement takes on a rough and jagged appearance.

Asphalt stripping refers to the degradation of the bond between the asphalt binder and the aggregate caused by moisture. Stripping is the result of a failure of the adhesion between the aggregate and the asphalt binder. Stripping occurs when water interacts with the asphalt binder and reduces its cohesive properties. The physical and chemical properties of both the aggregate and the asphalt can influence stripping caused by moisture. Stripping is also influenced by temperature and shear forces caused by tires on the roadway.

As asphalt ages, it also becomes stiffer due to oxidation caused by oxygen in the atmosphere. Oxidation can result in a loss of bonding capacity in the asphalt as it becomes more brittle. This can lead to stress cracking of the asphalt pavement.

Many additives have been used to attempt to reduce or eliminate the various types of moisture damage in asphalt pavements. Several of the additives used present drawbacks, such as limited temperature resistance or ecotoxicity. Lime is sometimes added to the aggregate prior to mixing with the asphalt binder to reduce moisture damage of the asphalt pavement. In one process, hydrated lime is slurried and sprayed over the aggregate material followed by curing for several days prior to mixing the aggregate with the asphalt.

It would be desirable to have an improved process for improving the stiffness and reducing the moisture damage of asphalt pavements.

### SUMMARY OF THE INVENTION

The present invention is directed, in one aspect, to improved asphalt pavement compositions containing calcium phosphate. The asphalt pavement compositions comprise aggregate, asphalt binder and calcium phosphate. “Calcium phosphate” as used herein and in the claims means any form, or combination of forms, of calcium phosphate, including monocalcium phosphate, anhydrous monocalcium phosphate, dicalcium phosphate, anhydrous dicalcium phosphate, tricalcium phosphate, hydroxyapatite, orthophosphate, metaphosphate, pyrophosphate, hydrogen or dihydrogen calcium phosphate, the calcium phosphate described in U.S. Publication No. 2008/0274264, or any combination of these materials.

A sufficient amount of calcium phosphate is added to the asphalt pavement mix to obtain the desired properties in the final composition. Typically, the amount of calcium phosphate added to the pavement mix will achieve a concentration of between 0.05% and 10% by weight of the asphalt pavement mix, more preferably between 0.5% and 7% by weight calcium phosphate, and even more preferably between 0.5% by weight and 2% by weight calcium phosphate. The asphalt pavement mix preferably contains between about 4% by weight and 9% by weight asphalt binder, and will typically contain about 5% by weight asphalt binder. The asphalt pavement mix contains between about 81% to about 95.95% by weight aggregate.

The asphalt pavement composition may also comprise phosphate salts that contain some amount of phosphoric acid and/or polyphosphoric acid within the porous portions of the phosphate salt may be added to the asphalt binder. The acids can provide additional functionality to modify the asphalt binder properties when released in the asphalt mix.

The asphalt pavement composition may include other additives to obtain further improvements or synergistic effects with the calcium phosphate. For example, gypsum, lime, sand or limestone may be added to the asphalt mixtures described above. Also, other additives used in asphalt mixes, such as for example polymers, crumb rubber or vulcanizing agents, may be added to the asphalt mix.

In another aspect, the invention relates to processes for producing an improved asphalt pavement mix by adding calcium phosphate. In one embodiment, calcium phosphate is added to aggregate material prior to mixing the aggregate material with the asphalt binder. In another embodiment, calcium phosphate is added to the asphalt binder prior to adding the aggregate to the asphalt binder. In yet another embodiment, calcium phosphate is produced in-situ by adding lime and a phosphoric acid or polyphosphoric acid to the asphalt binder. The lime and acid combine to form calcium phosphate.

Among the advantages of the asphalt pavement mixes of the present invention is that the asphalt pavement has an improved softening point and stiffness. Another advantage is that the asphalt pavement compositions exhibit improved moisture resistance. Other advantages of the pavement compositions and processes described herein will be apparent to those skilled in the art based upon the detailed description of the invention set forth below.

### DESCRIPTION OF INVENTION

The present invention is directed generally to improved asphalt pavement materials processes for preparing asphalt pavement materials that are less susceptible to moisture damage by adding a calcium phosphate compound to the aggregate prior to mixing the aggregate with the asphalt binder. The calcium phosphate may be provided in the form of monocalcium phosphate, anhydrous monocalcium phosphate, dicalcium phosphate, anhydrous dicalcium phosphate, tricalcium phosphate, hydroxyapatite or combinations of these materials. The invention is not limited in this regard, and it should be understood that the term “calcium phosphate” as used herein refers to any form, or combination of forms, of calcium phosphate, including those described above and any other calcium phosphate such as, for example, orthophosphate, metaphosphate or pyrophosphate. The calcium phosphate may also be a hydrogen or dihydrogen calcium phosphate, or the calcium phosphate described in U.S. Publication No. 2008/0274264, the contents of which are hereby incorporated by reference in their entirety.

In addition to, or in place of, calcium phosphate, phosphate salts that contain some amount of phosphoric acid and/or polyphosphoric acid within the porous portions of the phosphate salt may be added to the asphalt binder. The acids can provide additional functionality to modify the asphalt binder properties when released in the asphalt mix.

Any type of asphalt material, sometimes referred to as bitumen, used for manufacture of pavement mixes may be used in the pavement compositions of the present invention. The aggregate material may be any appropriate type of aggregate material. Typically, the aggregate material is crushed rock.

The calcium phosphate is combined with the asphalt binder and aggregate in the pavement mixture. The calcium phosphate may be added to the aggregate, or it may be blended with the asphalt binder prior to the addition of the aggregate. The amount of calcium phosphate added to the pavement mix is selected to achieve the desired properties in the final pavement product. Typically, the amount of calcium phosphate added to the pavement mix will achieve a concentration of between about 0.05% and about 10% by weight of the asphalt pavement mix. Calcium phosphate may be added to achieve a concentration of between about 0.5% and about 7% by weight calcium phosphate, and in some embodiments the calcium phosphate concentration may be between about 0.5% by weight and about 2% by weight of the asphalt pavement mix. The asphalt pavement mix preferably contains between about 4% by weight and 9% by weight asphalt binder, and will typically contain about 5% by weight asphalt binder. The asphalt pavement mix contains between about 81% to about 95.95% by weight aggregate. It should be understood that the proportions provided above refer to the relationship between the calcium phosphate, asphalt binder and aggregate only, and that there may be additional additives in any pavement mixture of the present invention.

In one embodiment of the invention, calcium phosphate is blended with the aggregate in dry form. The calcium phosphate may be added to an aggregate pile, or it may be added to the aggregate during the process of producing the asphalt pavement mix. As discussed above, calcium phosphate is blended with the aggregate to achieve a calcium phosphate level of between about 0.05% by weight to about 10% by weight of the total weight of the asphalt pavement mix. In some embodiments calcium phosphate is added to achieve a calcium phosphate level of between 0.5% and 7% by weight calcium phosphate, or between 0.5% by weight and 2% by weight calcium phosphate. The calcium phosphate treated aggregate is mixed with the asphalt binder using typical methods for combining additives with aggregate or with aggregate and asphalt binders known to those skilled in the art to produce an asphalt pavement material.

In another embodiment of the invention, calcium phosphate is added to the heated, liquid asphalt prior to mixing the asphalt with the aggregate. Calcium phosphate is blended with the liquid asphalt to achieve a calcium phosphate level of between about 0.05% by weight to about 10% by weight of the total weight of the asphalt pavement mix. In some embodiments calcium phosphate is added to achieve a calcium phosphate level of between 0.5% and 7% by weight calcium phosphate, or between 0.5% by weight and 2% by weight calcium phosphate. The asphalt binder is typically heated to a temperature of between about 100° C. and 230° C., preferably about 160° C. The asphalt and calcium phosphate are mixed for a sufficient time to disperse the calcium phosphate in the asphalt liquid, preferably for a time between about 30 minutes to about 24 hours.

In another embodiment of the invention, calcium phosphate is produced in-situ by mixing lime with asphalt that is treated with polyphosphoric acid (PPA). In this embodiment of the invention, the asphalt binder is typically heated to a temperature of between about 100° C. and 230° C., preferably about 160° C. PPA and lime are added to the heated asphalt with mixing. The asphalt, PPA and lime are mixed for a sufficient time to disperse the PPA and lime in the asphalt liquid, preferably for a time between about 30 minutes to about 24 hours. The lime may be added to asphalt either before or after PPA is added to the asphalt, or the lime and PPA may be added at the same time. The lime may be added in any desired form. In one embodiment, hydrated lime is added to the asphalt. A sufficient amount of lime and PPA are added to achieve a calcium phosphate concentration of between about 0.05% by weight to 10% by weight of the asphalt pavement mix. In some embodiments lime and acid are added to achieve a calcium phosphate level of between 0.5% and 7% by weight calcium phosphate, or between 0.5% by weight and 2% by weight calcium phosphate.

In another embodiment of the invention, a porous phosphate salt, such as hydroxyapatite, containing either phosphoric acid or polyphosphoric acid in the pores of the salt, is added to the asphalt binder. The phosphate salt may be added in combination with the calcium phosphate or it may be added without addition of the calcium phosphate. Preferably, the phosphate salt is added to the asphalt binder to achieve a concentration of the phosphate salt of between about 0.5% and about 3% of the weight of the asphalt pavement mix.

Other additives may be used to obtain further improvements or synergistic effects with the calcium phosphate. For example, gypsum, lime, sand or limestone may be added to the asphalt mixtures described above. Also, other additives used in asphalt mixes, such as for example polymers, crumb rubber or vulcanizing agents, may be added to the asphalt pavement mix.

The use of calcium phosphate increases the moisture resistance of the asphalt pavement product. In addition, calcium phosphate provides a significant increase in the stiffness of the asphalt pavement as compared to asphalt pavement containing only lime. This improves the rutting resistance of the asphalt pavement for heavy traffic situations.

Another benefit of the use of calcium phosphate is that it is compatible with other additives such as PPA, as well as asphalts containing PPA and polymers such as SBS rubber, styrene, crumb rubber or combinations of these or other polymers.

Table 1 below provides the results of tests performed measuring the softening point of PG 64-22 asphalt. The softening point of neat asphalt is compared to the softening point of asphalt with added lime (CaO), anhydrous CaHPO₄, and anhydrous Ca(H₂PO₄)₂. Two sets of tests were run, one using an asphalt binder containing 15% by weight of the additives, and a second set using an asphalt binder containing 50% by weight of the additives. As can be seen in Table 1, the samples with added calcium phosphate show an improved softening point as compared to neat asphalt and asphalt with added lime.

TABLE 1
Softening Point (° C.)

| | 1^{st} | 2^{nd} | Average |
|---|---|---|---|
| Sample Description | Reading | Reading | SP (° C.) |
| Neat PG 64-22 | 48.60 | 48.90 | 48.75 |
| PG 64-22 + 15% CaO | 50.10 | 50.10 | 50.10 |
| PG 64-22 + 15% CaHPO₄ | 51.10 | 50.40 | 50.75 |
| PG 64-22 + 15% Ca(H₂PO₄)₂ | 51.30 | 50.80 | 51.05 |
| Neat PG 64-22 | 49.40 | 48.80 | 49.10 |
| PG 64-22 + 50% CaO | 50.40 | 50.30 | 50.35 |
| PG 64-22 + 50% CaHPO₄ | 59.00 | 58.80 | 58.90 |
| PG 64-22 + 50% Ca(H₂PO₄)₂ | 57.80 | 57.50 | 57.65 |

As will be recognized by those skilled in the pertinent art based upon the teachings herein, numerous changes and modifications may be made to the above-described and other embodiments of the invention without departing from its scope as defined in the appended claims. Accordingly, this detailed description of preferred embodiments is to be taken in an illustrative as opposed to a limiting sense.

I claim:

1. An asphalt pavement composition comprising:
(a) between about 4% by weight to about 9% by weight of an asphalt binder;
(b) between about 81% by weight to about 95.95% by weight aggregate; and
(c) between 0.05% by weight to 10% by weight of calcium phosphate.

2. The composition of claim 1, wherein the calcium phosphate is selected from the group consisting of monocalcium phosphate, anhydrous monocalcium phosphate, dicalcium phosphate, anhydrous dicalcium phosphate, tricalcium phosphate, hydroxyapatite, orthophosphate, metaphosphate, pyrophosphate, hydrogen calcium phosphate, dihydrogen calcium phosphate, or combinations thereof.

3. The composition of claim 2, further comprising at least one additive selected from the group consisting of gypsum, lime, sand, limestone, polymers, crumb rubber or vulcanizing agents.

4. The composition of claim 2, further comprising a phosphate salt containing one of phosphoric acid or polyphosphoric acid.

5. A process for producing an asphalt pavement material comprising the steps of:
(a) providing an aggregate material;
(b) blending calcium phosphate with the aggregate material;
(c) mixing the aggregate and calcium phosphate blend with an asphalt binder.

6. The process of claim 5, wherein the calcium phosphate is selected from the group consisting of monocalcium phosphate, anhydrous monocalcium phosphate, dicalcium phosphate, anhydrous dicalcium phosphate, tricalcium phosphate, hydroxyapatite, orthophosphate, metaphosphate, pyrophosphate, hydrogen calcium phosphate, dihydrogen calcium phosphate, or combinations thereof.

7. The process of claim 5, wherein the asphalt pavement mixture comprises:
(a) between about 4% by weight to about 9% by weight of an asphalt binder;
(b) between about 81% by weight to about 95.95% by weight aggregate; and
(c) between 0.05% by weight to 10% by weight of calcium phosphate.

8. The process of claim 6, further comprising the step of adding at least one additive selected from the group consisting of gypsum, lime, sand, limestone, polymers, crumb rubber or vulcanizing agents.

9. The process of claim 6, further comprising the step of adding to the pavement mixture a phosphate salt containing one of phosphoric acid or polyphosphoric acid.

10. A process for producing an asphalt pavement material comprising the steps of:
(a) heating an asphalt binder to a temperature of between about 100° C. and 230° C.;
(b) adding calcium phosphate to the heated asphalt binder while mixing; and
(d) adding aggregate to the asphalt binder.

11. The process of claim 10, wherein the asphalt binder and calcium phosphate are mixed for a period between about 30 minutes and about 24 hours.

12. The process of claim 11, further comprising the step of adding at least one additive selected from the group consisting of gypsum, lime, sand, limestone, polymers, crumb rubber or vulcanizing agents.

13. The process of claim 11, further comprising the step of adding to the pavement mixture a phosphate salt containing one of phosphoric acid or polyphosphoric acid.

14. A process for producing an asphalt pavement material comprising the steps of:
(a) heating an asphalt binder to a temperature of between about 100° C. and 230° C.;
(b) adding PPA to the heated asphalt binder while mixing;
(c) adding lime to the heated asphalt binder while mixing; and
(d) adding aggregate to the asphalt binder after adding the PPA and the lime.

15. The process of claim 14, wherein the asphalt binder, PPA and lime are mixed for a period between about 30 minutes and about 24 hours.

16. The process of claim 15, further comprising the step of adding at least one additive selected from the group consisting of gypsum, lime, sand, limestone, polymers, crumb rubber or vulcanizing agents.

17. The process of claim 15, further comprising the step of adding to the pavement mixture a phosphate salt containing one of phosphoric acid or polyphosphoric acid.
